(19) United States
(12) Patent Application Publication
(10) Pub. No.: US 2014/0002447 A1
(43) Pub. Date: Jan. 2, 2014

(54) 3D IMAGE DISPLAY DEVICE AND DRIVING METHOD THEREOF

(71) Applicant: SAMSUNG DISPLAY CO., LTD., GyeonggiI-do (KR)

(72) Inventor: Yong Hwan SHIN, Guri-si (KR)

(73) Assignee: SAMSUNG DISPLAY CO., LTD., GYEONGGI-DO (KR)

(21) Appl. No.: 13/670,557

(22) Filed: Nov. 7, 2012

(30) Foreign Application Priority Data
Jun. 29, 2012 (KR) 10-2012-0070918

(51) Int. Cl. G02F 1/13; G09G 5/40

(52) U.S. Cl. CPC G02F 1/1313; G09G 5/40
USPC 345/419; 349/13

(57) ABSTRACT

A 3D image display device includes a 3D image display panel. A patterned retarder is formed on an entire surface of the 3D image display panel. 3D glasses include a lens. The lens includes an SG panel having liquid crystal molecules and a λ/4 plate on an upper surface of the SG panel. The 3D image display panel and the 3D glasses are synchronized.

### CROSS-REFERENCE TO RELATED APPLICATION

This application claims priority to and the benefit of Korean Patent Application No. 10-2012-0070918 filed in the Korean Intellectual Property Office on Jun. 29, 2012, the entire contents of which are incorporated herein by reference.

### TECHNICAL FIELD

The present invention relates to a display device, and more particularly, to a three-dimensional (3D) image display device and a driving method thereof.

### DISCUSSION OF THE RELATED ART

Three-dimensional (3D) display devices are gaining in popularity and prominence in the marketplace. 3D display devices permit the viewer to enjoy a sense of depth perception by sending slightly different images to each eye of the viewer. These images, including a left-eye image and a right-eye image, are rendered or captured from a slightly different vantage point that would be consistent with the manner in which a person naturally perceives left-eye and right-eye images from slightly different angles owing to the distance between the viewer's left eye and right eye, a phenomenon known as binocular disparity. By recreating this stereovision, 3D display devices are able to portray a convincing sensation of depth in the experience of the viewer.

3D display devices are classified as either stereoscopic type or autostereoscopic type. Stereoscopic type 3D display devices are characterized as requiring the viewer to wear a set of 3D glasses. An example of a stereoscopic type 3D display devices is a polarization type display, in which the left-eye image is projected having a first polarization and the right-eye image is projected having a second polarization and the 3D glasses include appropriate polarizing filters to filter out the undesired image at each eye. Another example of a stereoscopic type 3D display is the time division type display in which the display device alternates between displaying a left-eye image and a right-eye image and shutters within the 3D glasses are controlled to block out the undesired image at each eye.

Autostereoscopic type 3D displays are characterized by not requiring 3D glasses. An example of an autostereoscopic 3D display is a parallax-barrier type display in which the left-eye image and right-eye image are simultaneously displayed on the display device as interlaced stripes and a barrier layer, spaced apart from the display layer, blocks the left-eye stripes from being seen by the viewer's right eye and blocks the right-eye stripes from being seen by the viewer's left eye. Another example of an autostereoscopic 3D display is a lenticular type display in which a set of lenses spaced apart from the display layer guides the left-eye stripes to the viewer's left eye while guiding the right-eye stripes to the viewer's right eye.

When there is more than one viewer watching a single 3D display device of a stereoscopic type, it may be necessary for each viewer to have his or her own set of 3D glasses. When there is more than one viewer watching a single 3D display device of an autostereoscopic type, no 3D glasses are required but it may be difficult for the left-eye images to be projected to the left-eye of both viewers and for the right-eye images to be projected to the right-eye of both viewers. Thus, the quality of the 3D effect may be reduced for one or more of the multiple viewers.

### SUMMARY

Exemplary embodiments of the present invention provide a 3D image display device in which two or more users can watch different 3D images, and a driving method thereof.

An exemplary embodiment of the present invention provides a 3D image display device including a 3D image display panel including a patterned retarder on an entire surface thereof. 3D glasses are provided having a lens including an SG panel including liquid crystal molecules and a λ/4 plate on an upper surface of the SG panel. The 3D image display panel and the 3D glasses are synchronized.

The patterned retarder may include a first retarder and a second retarder longitudinally extending in left and right directions and alternately disposed.

The first retarder and the second retarder may be formed of the λ/4 plate, and the first retarder and the second retarder may be disposed such that slow axes of the λ/4 plates have different directions.

The 3D image display panel may include a first pixel row corresponding to the first retarder and a second pixel row corresponding to the second retarder.

The first pixel row and the second pixel row may be formed of one or more pixel rows.

The 3D image display panel may include a liquid crystal panel including polarizers attached to a lower portion and an upper portion thereof and a backlight.

The lens may include a left lens and a right lens, and the left lens and the right lens each include the SG panel, a lens lower polarizer, a lens upper polarizer, and the λ/4 plate.

The SG panel may include a pair of field generating electrodes and a liquid crystal layer.

There may be a 90° difference between polarization directions of two lights transmitted through the SG panel when an electric field is generated and when the electric field is not generated.

The slow axis of the λ/4 plate of the left lens may have the same direction as the slow axis of the λ/4 plate of the right lens.

A polarization axis of the lens upper polarizer of the left lens and the polarization axis of the lens upper polarizer of the right lens may form a 90° angle.

The polarization axis of the lens lower polarizer of the left lens and the polarization axis of the lens lower polarizer of the right lens may form a 90° angle.

An exemplary embodiment of the present invention provides a driving method of a 3D image display device including a 3D image display panel including a first retarder, a second retarder, and 3D glasses including an SG panel and a λ/4 plate. In a first step, an image is displayed to one eye in a first pixel row corresponding to the first retarder. In a second step, an image is displayed to the other eye in a second pixel row corresponding to the second retarder. The first step and the second step are sequentially repeated.

In the case where there are at least two users of the 3D image display device that want to watch different 3D images, the 3D image display device may divide a frame for each of at least two or more users, only a 3D image for a first user may be displayed in the frame for the first user through the repeated first and second steps, and only the 3D image for a second user may be displayed in the frame for the second user through the repeated first and second steps.

The 3D glasses of the second user may block light in the frame for the first user, and the 3D glasses of the first user may block light in the frame for the second user.

An electric field may be applied to the SG panel to allow the 3D glasses to block light.

In the case where the user other than the first user and the second user wants to watch the 3D image for the first user, the 3D glasses of the corresponding user may be identically operated to the 3D glasses of the first user.

In the case where the user perceives a 3D image that is not appropriate for the age of the user, the 3D glasses of the corresponding user may block light to selectively prevent the user from seeing the inappropriate subject matter.

The electric field may be applied to the SG panel to allow the 3D glasses to block light.

As described above, a patterned retarder is provided on an entire surface of a display panel and 3D glasses through which light is transmitted or not transmitted by on/off of a lens are included, such that two or more users can watch different 3D images. Further, according to an exemplary embodiment of the present invention, the same image may or may not be watched 3D by multiple users in accordance to the age of the user and the appropriateness of the subject matter for various ages.

3D glasses for use with a 3D image display device having a pattered retarder formed on an entire surface thereof include a lens. An SG panel is formed within the lens. A liquid crystal layer is formed within the SG panel. A λ/4 plate is formed on an upper surface of the SG panel. The 3D glasses are synchronized with the 3D image display device.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view showing a 3D image display device according to an exemplary embodiment of the present invention;

FIG. 2 is a cross-sectional view of the 3D image display device according to an exemplary embodiment of the present invention;

FIG. 3 is a cross-sectional view of 3D glasses according to an exemplary embodiment of the present invention;

FIG. 4 is a view showing a characteristic of light displayed in the 3D image display device according to an exemplary embodiment of the present invention;

FIGS. 5 and 6 are views showing how the characteristic of light provided in the 3D image display device of FIG. 4 is changed while light passes through the 3D glasses;

FIG. 7 is a view showing a driving method of the 3D image display device for providing different 3D images to two users according to an exemplary embodiment of the present invention;

FIGS. 8 to 15 are views showing how the characteristic of light provided by the 3D image display device of FIG. 7 is changed while light passes through the 3D glasses;

FIGS. 16 and 17 are views showing a driving method of the 3D image display device for providing different 3D images to three or more users; and

FIG. 18 is a view showing a driving method of the 3D image display device for displaying an image according to an age of a user according to an exemplary embodiment of the present invention.

### DETAILED DESCRIPTION OF THE EMBODIMENTS

Exemplary embodiments of the present invention will be described more fully hereinafter with reference to the accompanying drawings. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present.

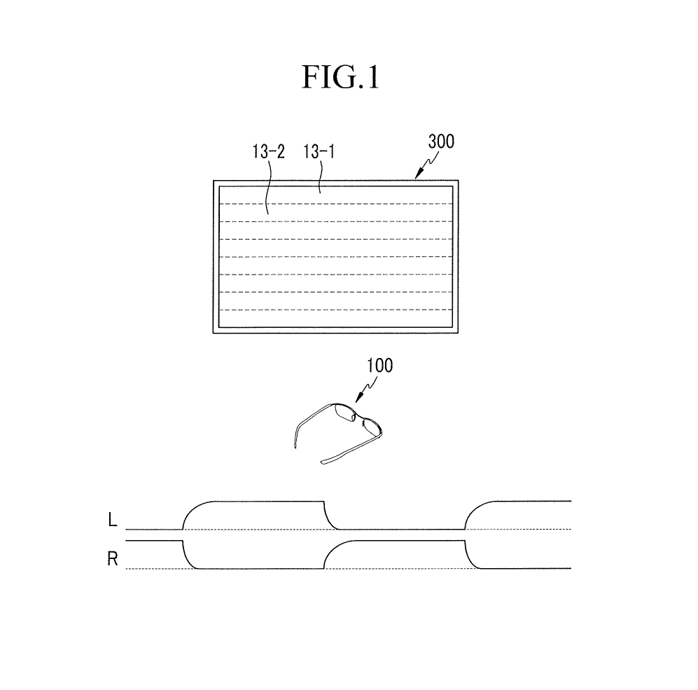

Now, a 3D image display device according to an exemplary embodiment of the present invention will be described in detail with reference to FIGS. 1 to 3.

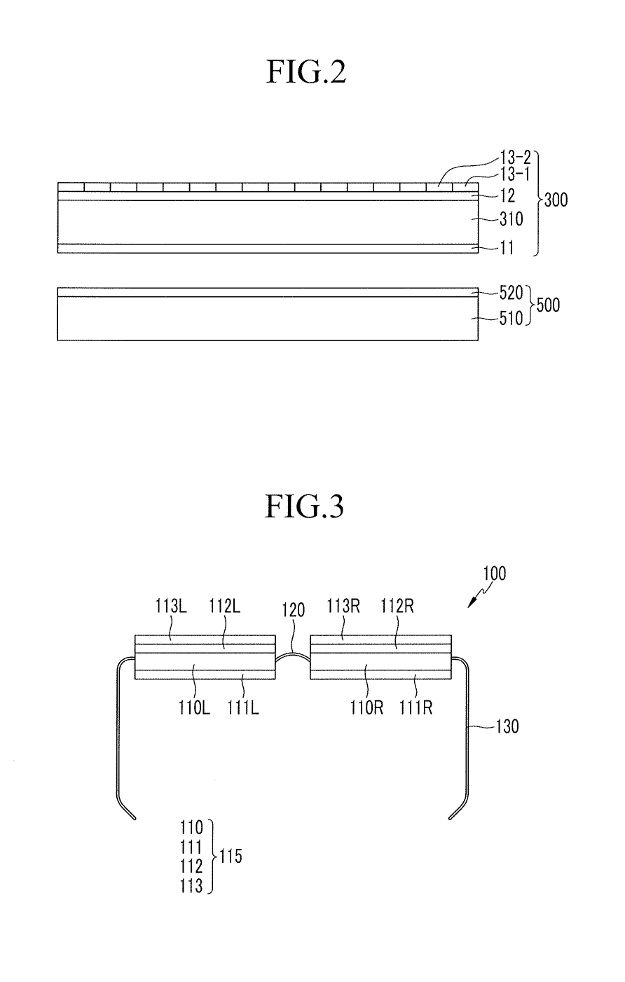

FIG. 1 is a view showing a 3D image display device according to an exemplary embodiment of the present invention, FIG. 2 is a cross-sectional view of the 3D image display device according to an exemplary embodiment of the present invention, and FIG. 3 is a cross-sectional view of 3D glasses according to an exemplary embodiment of the present invention.

The 3D image display device according to an exemplary embodiment of the present invention is constituted by a 3D image display panel 300 and 3D glasses 100, and the 3D image display panel 300 and the 3D glasses 100 are synchronized.

The 3D image display panel 300 includes patterned retarders 13-1 and 13-2 on an entire surface of a display panel (a flat display panel such as a liquid crystal panel, an organic light emitting panel, an electrophoretic display panel, and an electrowetting display panel). The 3D image display panel 300 provides two images having different polarization directions by the patterned retarders 13-1 and 13-2.

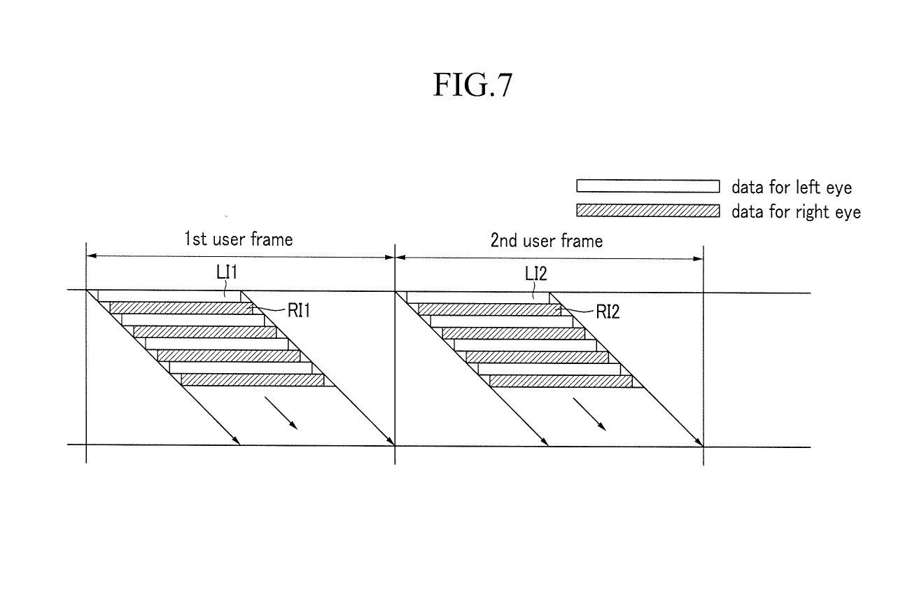

FIG. 1 shows two waveforms under the 3D glasses 100, in which a left lens L and a right lens R of the 3D glasses 100 are operated while being synchronized with the 3D image display panel 300. Herein, in the case where a high voltage is ensured, the corresponding lens may be in an on-state, and in the case where a low voltage is ensured, the corresponding lens may be in an off-state (light is not transmitted). However, according to an exemplary embodiment of the present invention, the lens may be in the on/off state only in the case where a plurality of users want to watch different 3D images in the 3D image display device, such that the waveform of FIG. 1 may be applied to of the approach illustrated in FIGS. 7 to 17.

Referring to FIG. 2, the 3D image display panel 300 according to an exemplary embodiment of the present invention employs a liquid crystal panel. Additionally, the 3D image display panel 300 according to an exemplary embodiment of the present invention further includes a backlight 500.

The backlight 500 is positioned on a rear surface of the liquid crystal panel 300, and includes a light source portion 510 including a light source and an optical sheet portion 520 for uniformly distributing light emitted from the light source portion 510 in a display region. A light guide may be included in the optical sheet portion 520.

The liquid crystal panel 300 is positioned on an upper portion of the backlight 500, and the liquid crystal panel 300 includes a liquid crystal substrate portion 310 including an upper substrate, a lower substrate, a pair of field generating electrodes, and a liquid crystal layer positioned therebetween. A lower polarizer 11 is attached to a lower surface of the liquid crystal substrate portion 310. An upper polarizer 12 is attached to an upper surface of the liquid crystal substrate portion 310. Patterned retarders 13-1 and 13-2 are attached onto the upper polarizer 12.

Directions of transmissive axes of the upper polarizer 12 and the lower polarizer 11 may be parallel or vertical to each other.

In the patterned retarders 13-1 and 13-2, as shown in FIG. 1, the first retarder 13-1 and the second retarder 13-2 longitudinally extending in left and right directions of the 3D image display panel 300 are alternately disposed.

The first retarder 13-1 and the second retarder 13-2 are each formed of a λ/4 plate, and arranged so that slow axes of the λ/4 plates have different directions, such that lights transmitted therethrough have different polarization directions. The directions of the slow axes of the λ/4 plates that are the first retarder 13-1 and the second retarder 13-2 may be vertical to each other. Further, the directions of the slow axes of the λ/4 plates that are the first retarder 13-1 and the second retarder 13-2 may form a 45° angle with the directions of transmissive axes of the upper polarizer 12 and the lower polarizer 11.

The first retarder 13-1 and the second retarder 13-2 may correspond to pixel rows formed on the liquid crystal substrate portion 310, and may each correspond to one pixel row or two or more pixel rows. Hereinafter, the pixel row corresponding to the first retarder 13-1 is called a first pixel row, and the pixel row corresponding to the second retarder 13-2 is called a second pixel row.

Referring to FIG. 3, the 3D glasses 100 according to an exemplary embodiment of the present invention include a lens 115, a lens connection portion 120, and a bridge portion 130. Herein, the lens 115 includes a left lens and a right lens. The lens 115 includes an SG panel 110 (R and L) (e.g. a shutter glass panel), a lens lower polarizer 111 (R and L), a lens upper polarizer 112 (R and L), and a λ/4 plate 113 (R and L).

The SG panel 110 of the lens 115 includes a pair of field generating electrodes and a liquid crystal layer. An arrangement direction of liquid crystal molecules in the liquid crystal layer is changed according to an electrode generated by the field generating electrode. In this case, the polarization direction of light is set to be changed to 90° or not to be changed by the arrangement direction of the liquid crystal molecules. In general, if TN (twisted nematic) liquid crystal is used, the polarization direction of light transmitted when the electric field is not generated may be set to be changed to 90°, and the polarization direction of light transmitted when the electric field is applied may be set not to be changed.

The lens lower polarizer 111 is positioned so as to be closest to the eyes in the lens 115 and the lens upper polarizer 112 is positioned on an upper portion of the SG panel 110, and the polarizers serve to block light or provide light to the eyes. The directions of transmissive axes of the lens lower polarizer 111 and the lens upper polarizer 112 may be vertical or parallel to each other.

The λ/4 plate 113 serves to change a circular polarization characteristic of light transmitted through the patterned retarders 13-1 and 13-2 of the liquid crystal panel 300 into a linear polarization characteristic. The direction of the slow axis of the λ/4 plate 113 may form a 45° angle with the directions of transmissive axes of the lens lower polarizer 111 and the lens upper polarizer 112.

The lens 115 has the left lens and the right lens, and there are the direction of the slow axis of the λ/4 plate 113 and the directions of transmissive axes of the lens lower polarizer 111 and the lens upper polarizer 112 in each of the lenses, accordingly, various combinations are feasible. However, when light having a predetermined polarization direction is transmitted through one lens, light having the corresponding polarization direction should not be transmitted through another lens in order to display the 3D image. The direction of the slow axis of the λ/4 plate 113 and the directions of transmissive axes of the lens lower polarizer 111 and the lens upper polarizer 112 may be set for this purpose. When it is desired that the viewer perceive a 3D image, the 3D image may be displayed by applying the electric field to the SG panel 110 of one lens and not applying the electric field to the SG panel 110 of the other lens so that one eye may only perceive light of one polarizing direction and the other eye may only perceive light of another polarizing direction.

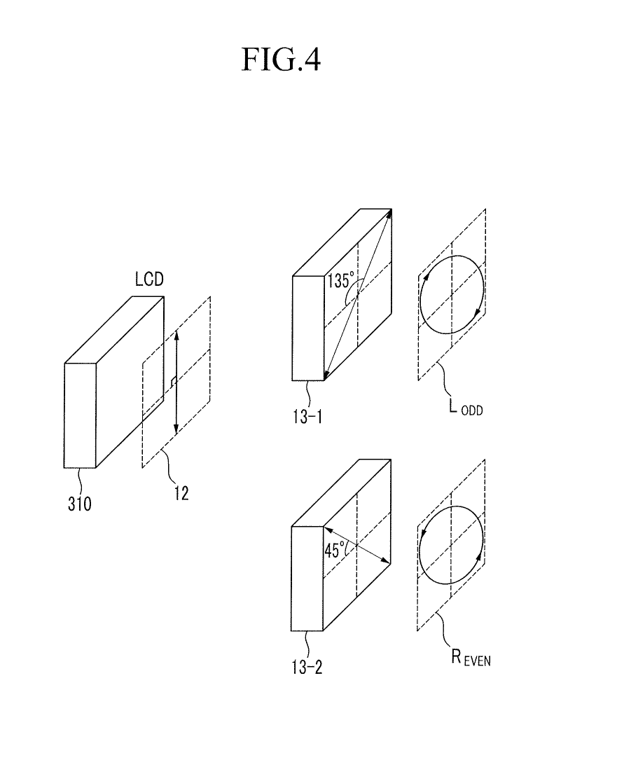

In the 3D image display device having the aforementioned structure, a polarization characteristic of light for providing the 3D image will be described in detail with reference to FIGS. 4 to 6.

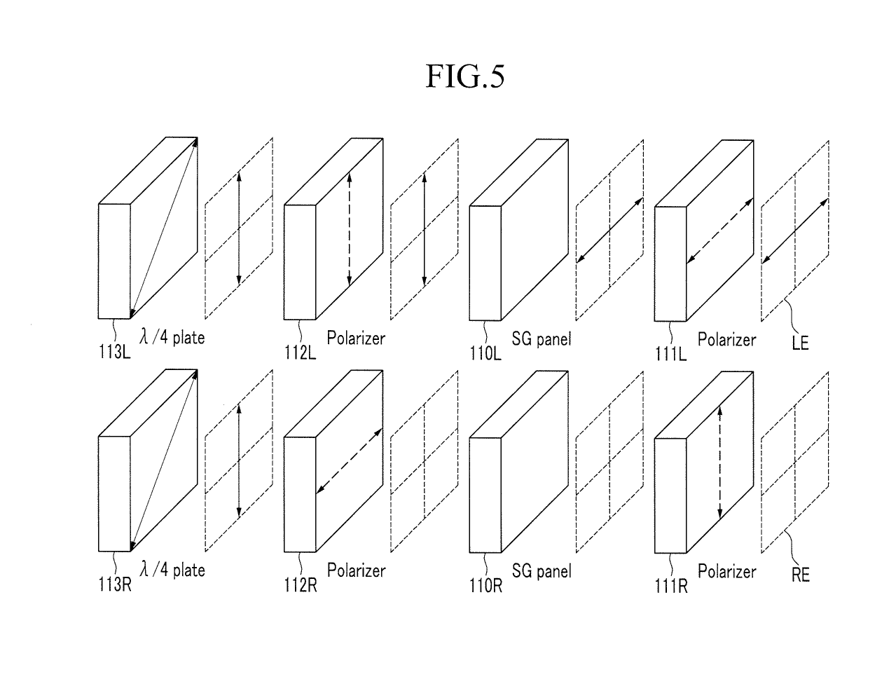

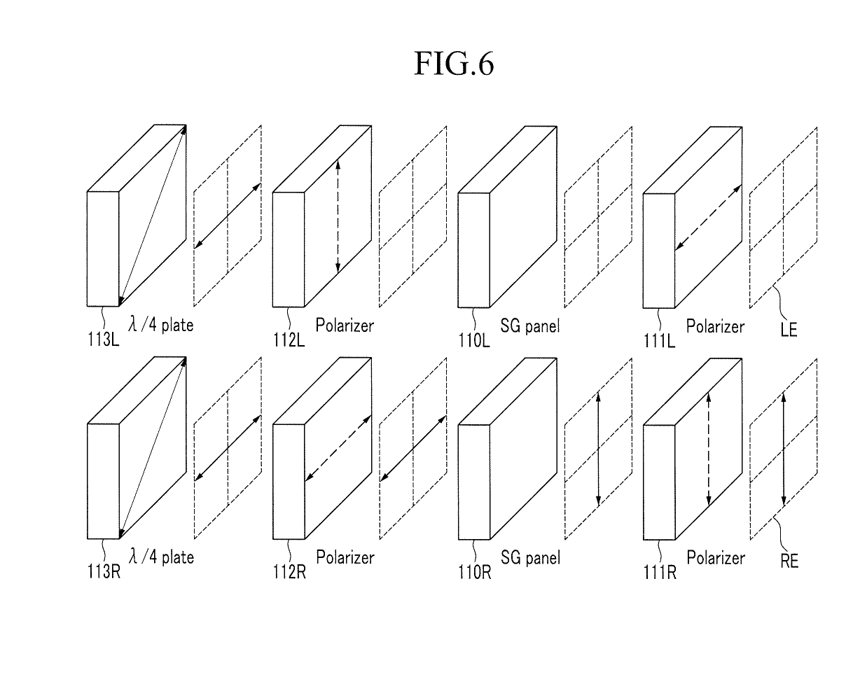

FIG. 4 is a view showing a characteristic of light displayed in the 3D image display device according to an exemplary embodiment of the present invention, and FIGS. 5 and 6 are views showing how the characteristic of light provided in the 3D image display device of FIG. 4 is changed while light passes through the 3D glasses.

As illustrated in FIG. 4, only the liquid crystal substrate portion 310, the upper polarizer 12 and the patterned retarders 13-1 and 13-2 are shown in the 3D image display panel 300. This is because the polarization characteristic of light provided by the 3D image display panel 300 is irrelevant to the direction of the transmissive axis of the lower polarizer 11.

In the 3D image display panel 300 according to an exemplary embodiment of the present invention is described with reference to FIG. 4. The direction of the transmissive axis of the upper polarizer 12 has a vertical direction, the slow axis of the first retarder 13-1 forms a 135° angle to the horizontal direction, and the slow axis of the second retarder 13-2 forms a 45° angle to the horizontal direction. As a result, the transmissive axis of the upper polarizer 12 and the slow axes of the first retarder 13-1 and the second retarder 13-2 form a 45° angle. The direction of the transmissive axis of the lower polarizer 11 may have the vertical direction or form a 90° angle thereto to have the horizontal direction like the direction of the transmissive axis of the upper polarizer 12.

As shown in FIG. 4, if light passing through the liquid crystal substrate portion 310 of the 3D image display panel 300 according to an exemplary embodiment of the present invention is transmitted through the upper polarizer 12, light has the polarization characteristic of the vertical direction like the direction of the transmissive axis of the upper polarizer 12. This arrangement may be shown, for example, by the arrow of the upper polarizer 12. Therefore light having the polarization direction that is vertical to the direction of the transmissive axis of the upper polarizer 12 is not transmitted through the upper polarizer 12 and the display may be black. As described above, light transmitted through the upper polarizer 12 to have the polarization direction of the vertical direction (light of vertical polarization) is incident on the first retarder 13-1 and the second retarder 13-2.

The polarization characteristic of light of vertical polarization that is incident on the first retarder 13-1 is changed into left-circular polarization. This change may be seen by the arrow represented by L_{ODD} of FIG. 4, This is change in polarization may be brought about by the first retarder 13-1 which is formed of the λ/4 plate and the slow axis and incident light form a 45° angle.

The polarization characteristic of light of vertical polarization that is incident on the second retarder 13-2 is changed into right-circular polarization. This arrangement may be seen by the arrow represented by R_{EVEN} of FIG. 4. The second retarder 13-2 is formed of the λ/4 plate and the slow axis and incident light form a 45° angle.

As described above, only light (L_{ODD}) of right-circular polarization and light (R_{EVEN}) of left-circular polarization are present in light emitted from the 3D image display panel 300 according to an exemplary embodiment of the present invention. The case where two lights are incident on the 3D glasses 100 will be described in detail with respect to FIGS. 5 and 6.

The 3D glasses 100 according to an exemplary embodiment of the present invention have a polarization characteristic as shown in FIG. 5. The left lens includes a left λ/4 plate 113L having the slow axis forming a 135° angle to the horizontal direction, a left lens upper polarizer 112L having the transmissive axis of the vertical direction, and a left lens lower polarizer 111L having the transmissive axis of the horizontal direction. Here, the left SG panel 110L is set so that when the electric field is not applied, the polarization axis of light is changed to 90°.

The right lens includes a right λ/4 plate 113R having the slow axis forming a 135° angle to the horizontal direction, a right lens upper polarizer 112R having the transmissive axis of the horizontal direction, and a right lens lower polarizer 111R having the transmissive axis of the vertical direction. Herein, the right SG panel 110R is set so that when the electric field is not applied, the polarization axis of light is changed to 90°.

The case where right-circular polarization is incident on the 3D glasses 100 is shown in FIG. 5, and the case where left-circular polarization is incident is shown in FIG. 6.

The case where light (L_{ODD}) of right-circular polarization is incident will be described in detail with respect to FIG. 5.

In FIG. 5, the drawing of the upper portion relates to the left lens, and the drawing of the lower portion relates to the right lens.

The case where light (L_{ODD}) of right-circular polarization is incident on the left lens will be described.

If light (L_{ODD}) of right-circular polarization is transmitted through the left λ/4 plate 113L, the polarization direction is changed to the vertical direction of light. Thereafter, light of the vertical direction is incident on the left lens upper polarizer 112L. Since the left lens upper polarizer 112L has the transmissive axis of the vertical direction, light is transmitted therethrough is unchanged. Thereafter, the polarization axis is changed to 90° while light is transmitted through the left SG panel 110L, such that light is changed into light of the horizontal direction. Thereafter, light of the horizontal direction is incident on the left lens lower polarizer 111L. Since the left lens lower polarizer 111L has the transmissive axis of the horizontal direction, light is transmitted therethrough in the state that it is to be transferred to the left eye (LE). As a result, the left eye recognizes the image.

However, the case where light (L_{ODD}) of the right-circular polarization is incident on the right lens is shown in the drawing of the lower portion of FIG. 5.

If light (L_{ODD}) of right-circular polarization is transmitted through the right λ/4 plate 113R, the polarization direction is changed to the vertical direction of light. Thereafter, light of the vertical direction is incident on the right lens upper polarizer 112R. Since the right lens upper polarizer 112R has the transmissive axis of the horizontal direction, light is not transmitted therethrough but is blocked. As a result, the right eye cannot recognize the image.

Therefore, as shown in FIG. 5, when the electric field is not applied to the SG panel 110, light (L_{ODD}) of right-circular polarization is recognized by only the left eye.

Hereinafter, the case where light (R_{EVEN}) of left-circular polarization is incident will be described in detail with respect to FIG. 6.

In FIG. 6, the drawing of the upper portion relates to the left lens, and the drawing of the lower portion relates to the right lens.

The case where light (R_{EVEN}) of left-circular polarization is incident on the left lens will be described.

If light (R_{EVEN}) of left-circular polarization is transmitted through the left λ/4 plate 113L, the polarization direction is changed to the horizontal direction of light. Thereafter, light of the horizontal direction is incident on the left lens upper polarizer 112L. Since the left lens upper polarizer 112L has the transmissive axis of the vertical direction, light is not transmitted therethrough but is blocked. As a result, the left eye cannot recognize the image.

The case where light (R_{EVEN}) of the left-circular polarization is incident on the right lens is shown in the drawing of the lower portion of FIG. 6.

If light (R_{EVEN}) of left-circular polarization is transmitted through the right λ/4 plate 113R, the polarization direction is changed to the horizontal direction of light. Thereafter, light of the horizontal direction is incident on the right lens upper polarizer 112R. Since the right lens upper polarizer 112R has the transmissive axis of the horizontal direction, light is transmitted therethrough unchanged. Thereafter, the polarization axis is changed to 90° while light is transmitted through the right SG panel 110R, such that light is changed into light of the vertical direction. Thereafter, light of the vertical direction is incident on the right lens lower polarizer 111R. Since the right lens lower polarizer 111R has the transmissive axis of the vertical direction, light is transmitted therethrough in the state that it is to be transferred to the right eye (RE). As a result, the right eye recognizes the image.

Therefore, as shown in FIG. 6, when the electric field is not applied to the SG panel 110, light (R_{EVEN}) of left-circular polarization is recognized by only the right eye.

Referring to characteristics of the 3D glasses 100 like FIGS. 5 and 6, if only the image to be transferred to the left eye is displayed in the first pixel row corresponding to the first retarder 13-1 of the 3D image display panel 300 and only the image to be transferred to the right eye is displayed in the second pixel row corresponding to the second retarder 13-2, different images are provided to the left eye and the right eye, such that a user perceives the 3D image due to binocular disparity (stereography).

This may be applied when the 3D image is provided to one user. Further, in the case where a plurality of users wear 3D glasses 100 (3D glasses of FIGS. 5 and 6) having the same polarization characteristic, the same 3D image may be provided to a plurality of users.

According to an exemplary embodiment of the present invention, different 3D images may be provided to a plurality of two or more users.

The case where different 3D images are provided to two or more users will be described with reference to FIGS. 7 to 15.

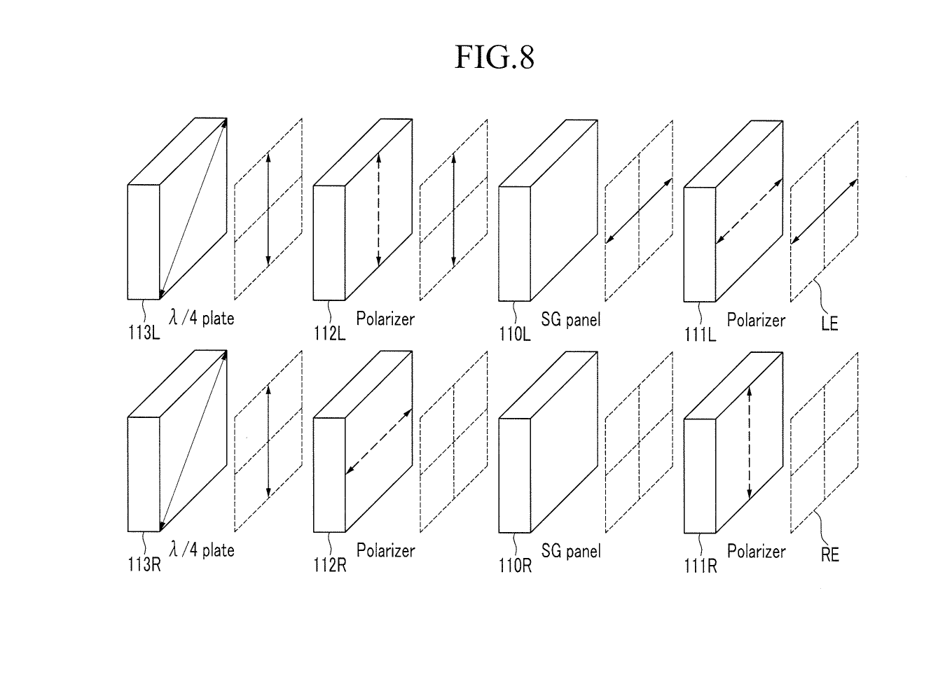

FIG. 7 is a view showing a driving method of the 3D image display device for providing different 3D images to two users according to an exemplary embodiment of the present invention, and FIGS. 8 to 15 are views showing how the characteristic of light provided by the 3D image display device of FIG. 7 is changed while light passes through the 3D glasses.

Referring to FIG. 7, one 3D image display panel 300 is divided to divide the frame so that the images are individually displayed to the two users. For example, the 3D image to be provided to a first user (1st user) is displayed in a first frame, and the 3D image to be provided to a second user (2nd user) is displayed in a second frame. Thereafter, the 3D image for the first user is displayed in odd-numbered frames and the 3D image for the second user is displayed in even-numbered frames. As described above, in one 3D image display panel 300, time is divided into a frame in which the 3D image to be provided to the first user is displayed (frame for the first user (1st user frame)) and a frame in which the 3D image to be provided to the second user is displayed (frame for the second user (2nd user frame)).

In the frame for the first user, the image LI1 (left image for the first user) to be transferred to the left eye of the first user is displayed in the first pixel row corresponding to the first retarder 13-1 of the 3D image display panel 300, and the image RI1 (right image for the first user) to be transferred to the right eye among the 3D images for the first user is displayed in the second pixel row corresponding to the second retarder 13-2. In FIG. 7, the left image LI1 for the first user and the right image RI1 for the first user are arranged in a right lower direction, which shows that a time displaying the lower pixel row is positioned behind a time displaying the upper pixel row in the 3D image display panel 300. However, this figure is not intended to convey that the pixel rows are structurally positioned in a diagonal direction in the 3D image display panel 300.

Thereafter, in the frame for the second user, the image LI2 (left image for the second user) to be transferred to the left eye of the second user is displayed in the first pixel row corresponding to the first retarder 13-1 of the 3D image display panel 300, and the image RI2 (right image for the second user) to be transferred to the right eye of the second user is displayed in the second pixel row corresponding to the second retarder 13-2.

Operation and polarization characteristics of the 3D glasses 100 worn by the two users when frames for two users are staggered is shown in FIG. 7. FIGS. 8 to 15 show the 3D images being individually displayed in the 3D image display panel 300.

FIG. 8 illustrates the manner in which the left image among the images for the first user is provided to the first user in the frame for the first user. Referring to FIG. 7, since the left image among the images for the first user corresponds to the first retarder 13-1, the left image has a characteristic of right-circular polarization.

Therefore, like the case described above with reference to FIG. 5, the polarization characteristic of light is changed, and the left image among the images for the first user is provided to only the left eye of the first user.

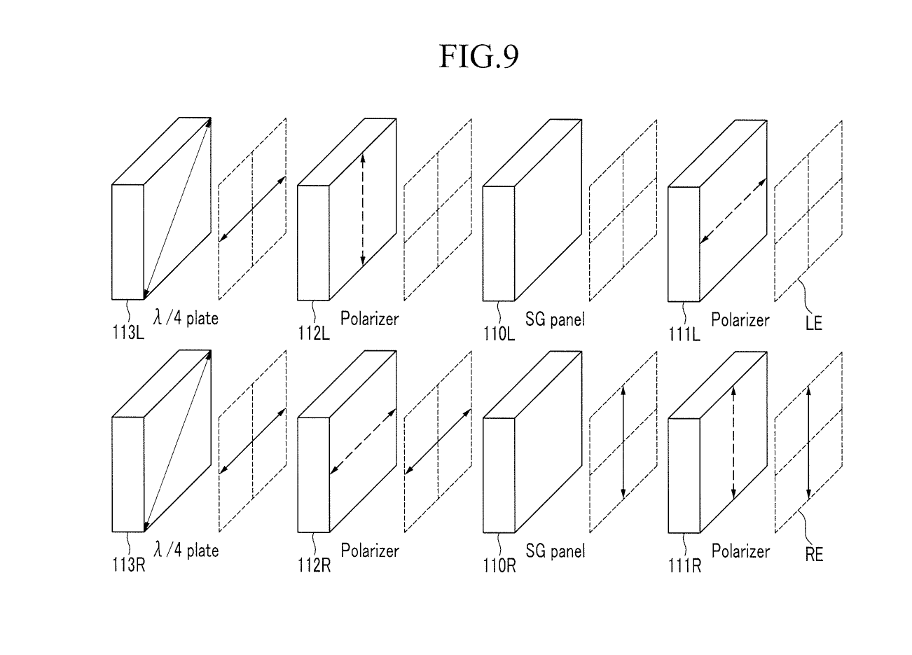

FIG. 9 illustrates the manner in which the right image among the images for the first user is provided to the first user in the frame for the first user. Referring to FIG. 7, since the right image among the images for the first user corresponds to the second retarder 13-2, the right image has a characteristic of left-circular polarization.

Therefore, as is shown in FIG. 6, the polarization characteristic of light is changed, and the right image among the images for the first user is provided to only the right eye of the first user.

Referring to FIGS. 8 and 9, the first user recognizes the 3D image in the frame for the first user. In an exemplary embodiment of the present invention, the electric field is not applied to the SG panel 110 of the 3D glasses for the first user in the frame for the first user.

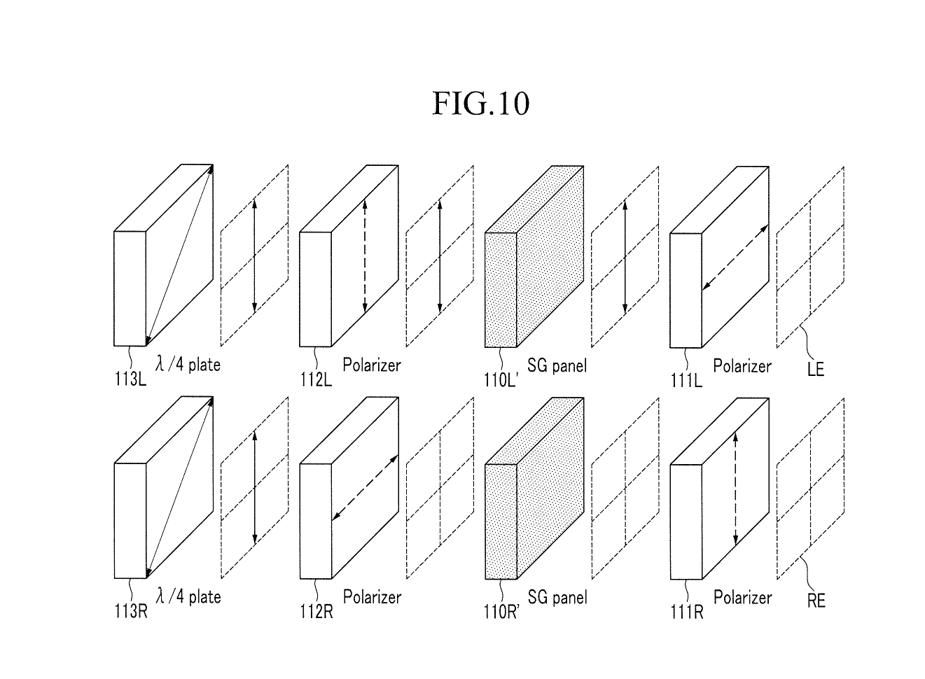

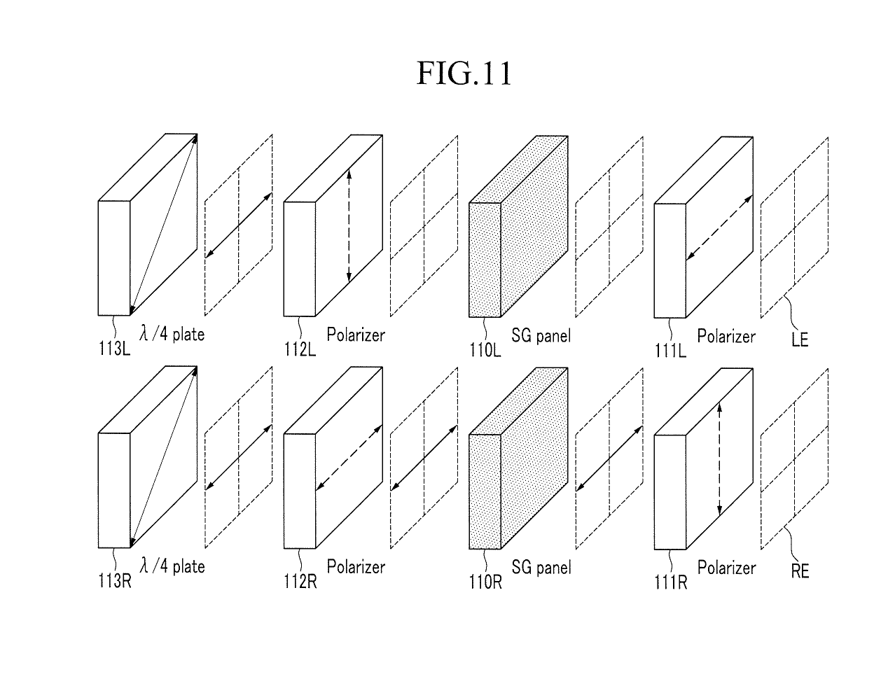

In the following FIGS. 10 and 11, the polarization characteristic of the image provided to the second user in the frame for the first user is shown. According to an exemplary embodiment, the electric field is applied to the SG panel 110 of the 3D glasses 100 of the second user in the frame for the first user so as not to change the polarization axis of transmitted light.

FIG. 10 illustrates a case in which the left image among the images for the first user is provided to the second user in the frame for the first user.

Since the left image among the images for the first user has the characteristic of right-circular polarization, in the case where light (L_{ODD}) of right-circular polarization is incident on the left lens of the 3D glasses for the second user, the polarization characteristic is changed as described below.

If light (L_{ODD}) of right-circular polarization is transmitted through the left λ/4 plate 113L, the polarization direction is changed to the vertical direction of light. Thereafter, light of the vertical direction is incident on the left lens upper polarizer 112L. Since the left lens upper polarizer 112L has the transmissive axis of the vertical direction, light is transmitted therethrough unchanged. Thereafter, light of the vertical direction is incident on the left SG panel 110L, and in this case, the electric field is applied to the left SG panel 110L so as not to change the polarization axis of transmitted light. Therefore, light transmitted through the left SG panel 110L has the polarization characteristic of the vertical direction. Thereafter, light of the vertical direction is incident on the left lens lower polarizer 111L. Since the left lens lower polarizer 111L has the transmissive axis of the horizontal direction, light is not transmitted therethrough but is blocked. As a result, the left eye of the second user cannot recognize the image.

Where light (L_{ODD}) of right-circular polarization is incident on the right lens of the 3D glasses for the second user, the polarization characteristic is changed as described below.

If light (L_{ODD}) of right-circular polarization is transmitted through the right λ/4 plate 113R, the polarization direction is changed to the vertical direction of light.

Thereafter, light of the vertical direction is incident on the right lens upper polarizer 112R. Since the right lens upper polarizer 112R has the transmissive axis of the horizontal direction, light is not transmitted therethrough but is blocked. As a result, the right eye of the second user cannot recognize the image.

FIG. 11 illustrates a case in which the right image among the images for the first user is provided to the second user in the frame for the first user.

Since the right image among the images for the first user has the characteristic of left-circular polarization, in the case where light (R_{EVEN}) of left-circular polarization is incident on the left lens of the 3D glasses for the second user, the polarization characteristic is changed as described below.

If light (R_{EVEN}) of left-circular polarization is transmitted through the left λ/4 plate 113L, the polarization direction is changed to the horizontal direction of light. Thereafter, light of the horizontal direction is incident on the left lens upper polarizer 112L. Since the left lens upper polarizer 112L has the transmissive axis of the vertical direction, light is not transmitted therethrough but is blocked. As a result, the left eye of the second user cannot recognize the image.

Where light (R_{EVEN}) of left-circular polarization is incident on the right lens of the 3D glasses for the second user, the polarization characteristic is changed as described below.

If light (R_{EVEN}) of left-circular polarization is transmitted through the right λ/4 plate 113R, the polarization direction is changed to the horizontal direction of light. Thereafter, light of the horizontal direction is incident on the right lens upper polarizer 112R. Since the right lens upper polarizer 112R has the transmissive axis of the horizontal direction, light is transmitted therethrough unchanged. Thereafter, light of the horizontal direction is incident on the right SG panel 110R, and in this case, the electric field is applied to the right SG panel 110R so as not to change the polarization axis of transmitted light. Therefore, light transmitted through the right SG panel 110R has the polarization characteristic of the horizontal direction. Thereafter, light of the horizontal direction is incident on the right lens lower polarizer 111R. Since the right lens lower polarizer 111R has the transmissive axis of the vertical direction, light is not transmitted therethrough but is blocked. As a result, the right eye of the second user cannot recognize the image.

Therefore, referring to FIGS. 10 and 11, the second user does not recognize the image in the frame for the first user but instead sees only black.

Only the first user recognizes the 3D image and the second user sees only the black image in the frame for the first user due to the aforementioned polarization characteristics such as are illustrated in FIGS. 8 to 11.

It should be noted, however, that even thought the second user sees a black image in the frame for the first user, the second user may not be aware of this fact as the frame rate of the 3D display device may be very high and frames that are recognized by the second user may still be close enough together in time that the second user does not perceive the reduction in frame rate.

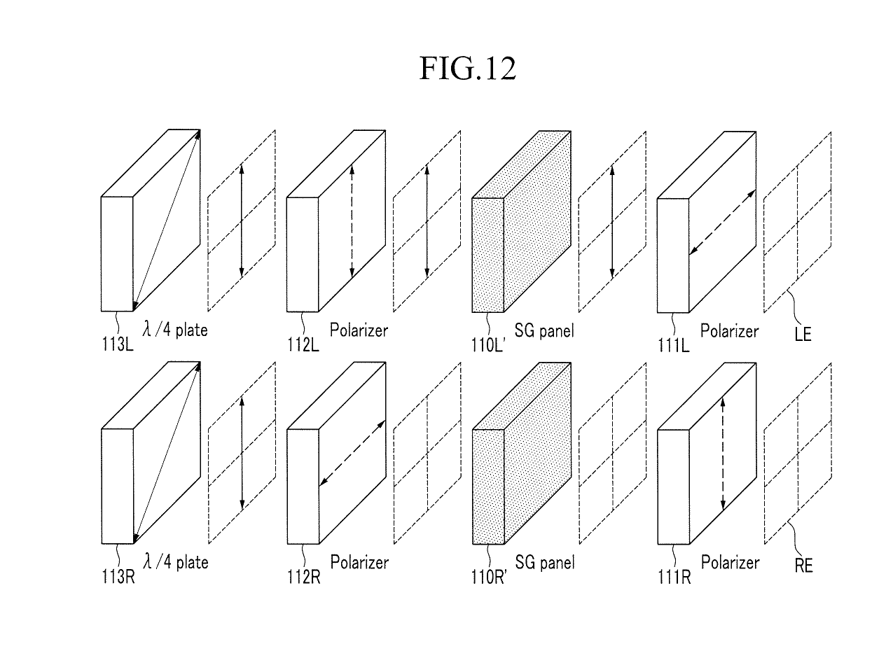

In FIGS. 12 to 15, the polarization characteristic in the frame for the second user is shown. According to an exemplary embodiment, the electric field is applied to the

SG panel 110 of the 3D glasses 100 of the first user in the frame for the second user so as not to change the polarization axis of transmitted light.

FIG. 12 illustrates a case in which the left image among the images for the second user is provided to the first user in the frame for the second user.

Since the left image among the images for the second user has the characteristic of right-circular polarization, in the case where light (L_{ODD}) of right-circular polarization is incident on the left lens of the 3D glasses for the first user, the polarization characteristic is changed as described below.

If light (L_{ODD}) of right-circular polarization is transmitted through the left λ/4 plate 113L, the polarization direction is changed to the vertical direction of light. Thereafter, light of the vertical direction is incident on the left lens upper polarizer 112L. Since the left lens upper polarizer 112L has the transmissive axis of the vertical direction, light is transmitted therethrough unchanged. Thereafter, light of the vertical direction is incident on the left SG panel 110L, and in this case, the electric field is applied to the left SG panel 110L so as not to change the polarization axis of transmitted light. Therefore, light transmitted through the left SG panel 110L has the polarization characteristic of the vertical direction. Thereafter, light of the vertical direction is incident on the left lens lower polarizer 111L. Since the left lens lower polarizer 111L has the transmissive axis of the horizontal direction, light is not transmitted therethrough but is blocked. As a result, the left eye of the first user cannot recognize the image.

In the case where light (L_{ODD}) of right-circular polarization is incident on the right lens of the 3D glasses for the first user, the polarization characteristic is changed as described below.

If light (L_{ODD}) of right-circular polarization is transmitted through the right λ/4 plate 113R, the polarization direction is changed to the vertical direction of light. Thereafter, light of the vertical direction is incident on the right lens upper polarizer 112R. Since the right lens upper polarizer 112R has the transmissive axis of the horizontal direction, light is not transmitted therethrough but is blocked. As a result, the right eye of the second user cannot recognize the image.

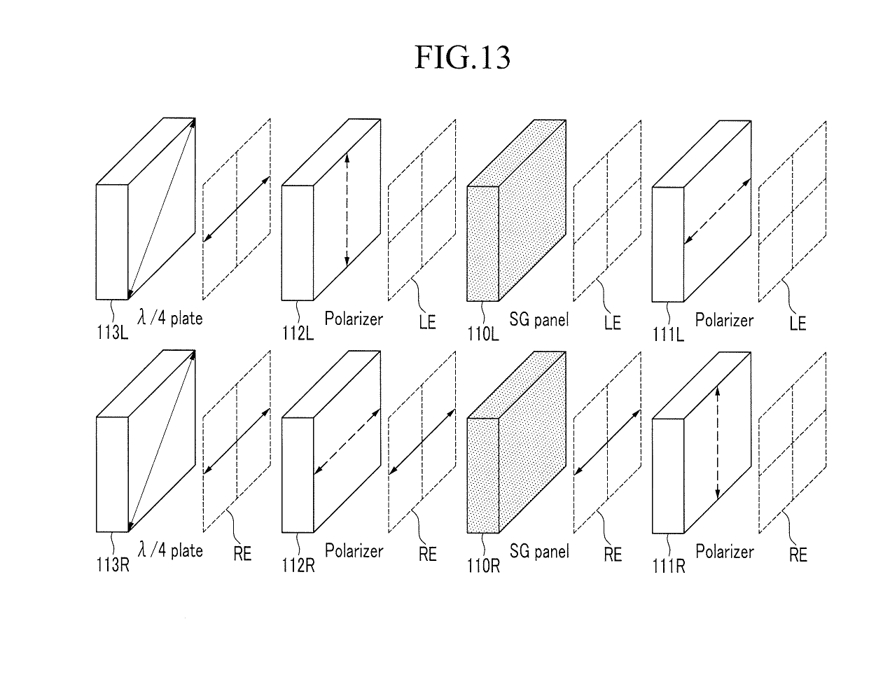

FIG. 13 illustrates a case in which the right image among the images for the second user is provided to the first user in the frame for the second user.

Since the right image among the images for the second user has the characteristic of left-circular polarization, in the case where light (R_{EVEN}) of left-circular polarization is incident on the left lens of the 3D glasses for the first user, the polarization characteristic is changed as described below.

If light (R_{EVEN}) of left-circular polarization is transmitted through the left λ/4 plate 113L, the polarization direction is changed to the horizontal direction of light. Thereafter, light of the horizontal direction is incident on the left lens upper polarizer 112L. Since the left lens upper polarizer 112L has the transmissive axis of the vertical direction, light is not transmitted therethrough but is blocked. As a result, the left eye of the first user cannot recognize the image.

Where light (R_{EVEN}) of left-circular polarization is incident on the right lens of the 3D glasses for the first user, the polarization characteristic is changed as described below.

If light (R_{EVEN}) of left-circular polarization is transmitted through the right λ/4 plate 113R, the polarization direction is changed to the horizontal direction of light. Thereafter, light of the horizontal direction is incident on the right lens upper polarizer 112R. Since the right lens upper polarizer 112R has the transmissive axis of the horizontal direction, light is transmitted therethrough unchanged. Thereafter, light of the horizontal direction is incident on the right SG panel 110R, and in this case, the electric field is applied to the right SG panel 110R so as not to change the polarization axis of transmitted light. Therefore, light transmitted through the right SG panel 110R has the polarization characteristic of the horizontal direction. Thereafter, light of the horizontal direction is incident on the right lens lower polarizer 111R. Since the right lens lower polarizer 111R has the transmissive axis of the vertical direction, light is not transmitted therethrough but is blocked. As a result, the right eye of the first user cannot recognize the image.

As seen in FIGS. 12 and 13, the first user sees only black in the frame for the second user.

From the point of view of the first user, if the frame for the first user and the frame for the second user are repeated, the 3D image and the black frame are repeatedly recognized, and the 3D image can be recognized between the black frames.

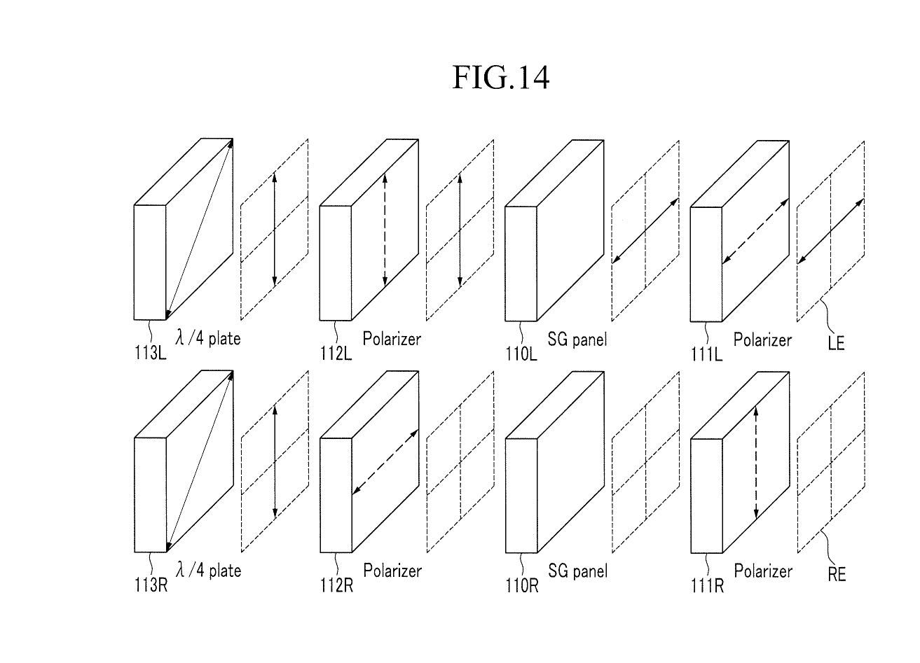

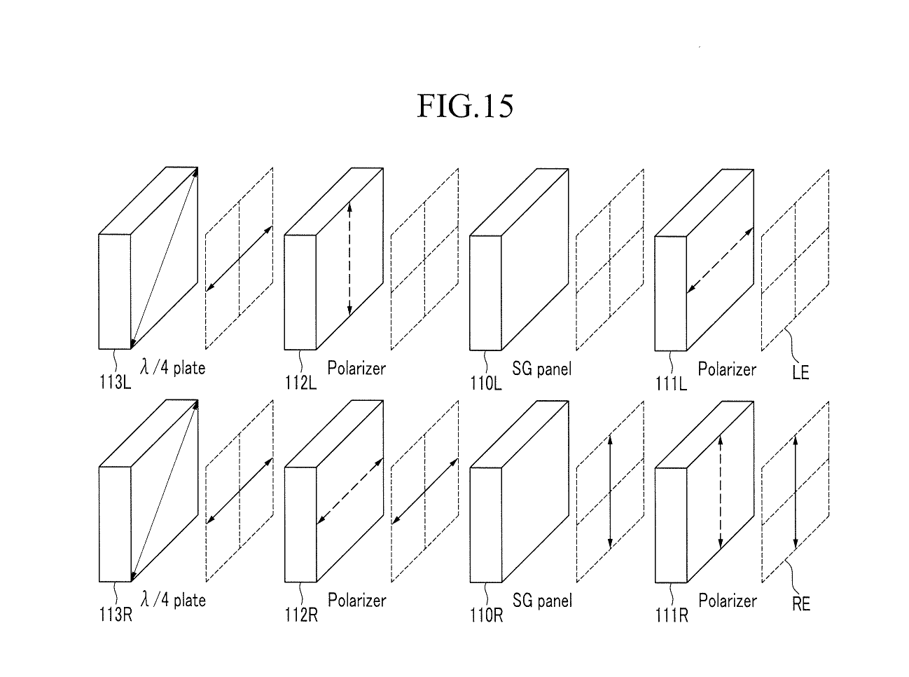

Hereinafter, the point of view of the second user in the frame for the second user will be described with reference to FIGS. 14 and 15. According to exemplary embodiments of the present invention, the electric field is not applied to the SG panel 110 of the 3D glasses for the second user in the frame for the second user.

FIG. 14 illustrates a case in which the left image among the images for the second user is provided to the second user in the frame for the second user.

Since the left image among the images for the second user corresponds to the first retarder 13-1, the left image has a characteristic of right-circular polarization. Therefore, like the case described above with reference to FIG. 5, the polarization characteristic of light is changed, and the left image among the images for the first user is provided to only the left eye of the first user.

FIG. 15 illustrates a case in which the right image among the images for the second user is provided to the second user in the frame for the second user.

Since the right image among the images for the second user corresponds to the second retarder 13-2, the right image has a characteristic of left-circular polarization. Therefore, as is described above with respect to FIG. 6, the polarization characteristic of light is changed, and the right image among the images for the first user is provided to only the right eye of the first user.

Referring to FIGS. 14 and 15, the second user recognizes the 3D image in the frame for the second user.

From the point of view of the second user, if the frame for the first user and the frame for the second user are repeated, the black and the 3D image are repeatedly recognized, and the 3D image can be recognized between the black frames.

FIGS. 7 to 15 illustrate an approach for providing different 3D images to multiple users according to exemplary embodiments of the present invention. It should be understood that while exemplary embodiments of the present invention are described with respect to two users, the described approach may be extended to additional users viewing either the same 3D image as one of the two described users or viewing additional different images. However, as each viewer may only see a non-black image frame for every other frame, the 3D image display panel 300 may be driven at a rate of 120 Hz in order for each viewer to perceive non-black frames at a rate of 60 Hz. Additionally, where there are three users viewing unique 3D images, the 3D image display panel 300 may be driven at a rate of 180 Hz or more.

According to exemplary embodiments, the 3D image display panel 300 can display two different 3D images, and the user can selectively watch the desired 3D image. In this case, the number of users may be more than two, for example, two or more users may watch the same 3D image. In the 3D glasses of the users watching the same 3D image, voltages are identically applied to the respective SG panels 110 at the same time to generate an identical electric field.

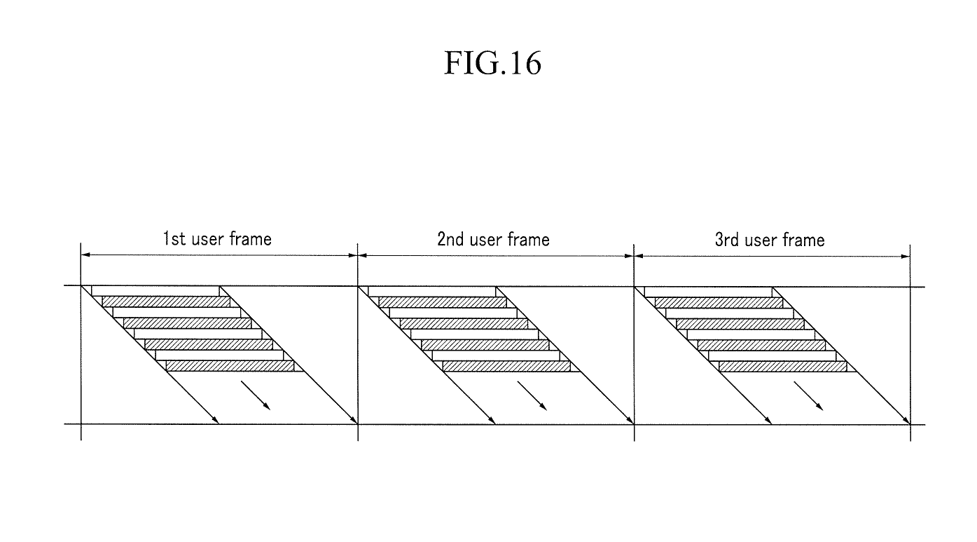

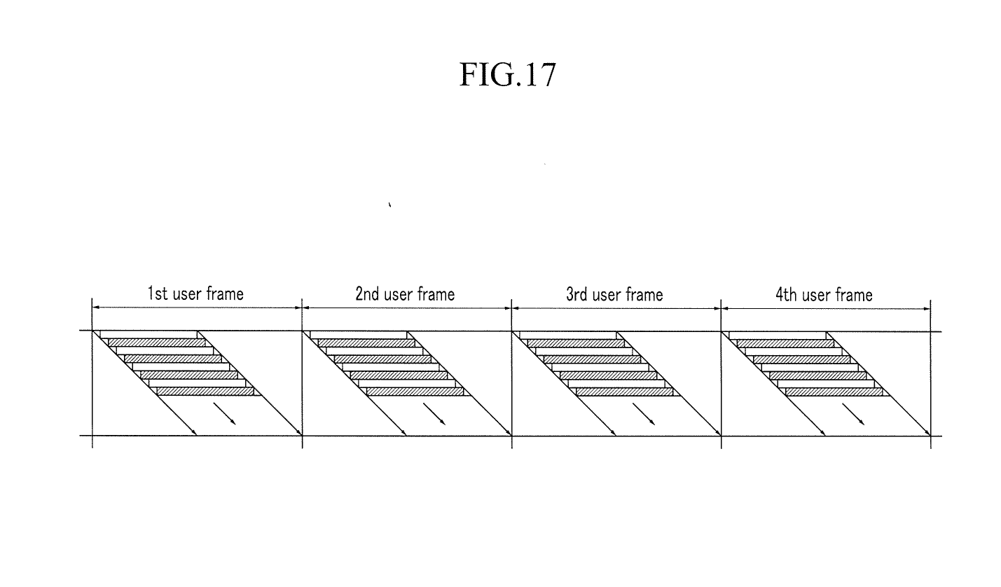

Hereinafter, the case where the number of users is three and four will be described with reference to FIGS. 16 and 17.

FIGS. 16 and 17 are views showing a driving method of the 3D image display device for providing different 3D images to three or more users, which correspond to FIG. 7.

As illustrated in FIG. 16, one 3D image display panel 300 is temporally divided into the frame for the first user, the frame for the second user and a frame for a third user to display different 3D images to three users.

In this case, the electric field may be applied to the SG panel 110 of the 3D glasses 100 for those users desiring to watch a frame that is presently displayed, and the electric field may not be applied to other frames.

As a result, each user recognizes a black frame during two frames among three adjacent frames, and recognizes the 3D image desired by the user during one frame of every three. In the case where the 3D image is recognized at 60 Hz, the 3D image display panel 300 needs to be driven at 180 Hz.

According to exemplary embodiments, the 3D image display panel 300 may display three different 3D images, and the user may selectively watch the desired 3D image. In this case, the number of users may be more than three, for example, where two or more users watch the same 3D image. In the 3D glasses of the users watching the same 3D image, voltages are identically applied to the SG panels 110 of each set of 3D glasses at the same time to generate an identical electric field.

As illustrated in in FIG. 17, one 3D image display panel 300 is temporally divided into the frame for the first user, the frame for the second user the frame for the third user, and a frame for a fourth user to display different 3D images to four users.

In this case, the electric field may not be applied to the SG panel 110 of the 3D glasses 100 for those users desiring to watch a frame that is presently displayed, and the electric field may not be applied to other frames.

As a result, each user recognizes a black frame during three frames among four adjacent frames, and recognizes the 3D image desired by the user during one frame of every three. In the case where the 3D image is recognized at 60 Hz, the 3D image display panel 300 needs to be driven at 240 Hz.

According to an exemplary embodiment, the 3D image display panel 300 may display four different 3D images, and the user may selectively watch the desired 3D image. In this case, the number of users may be more than four, for example, two or more users watch the same 3D image. In the 3D glasses of the users watching the same 3D image, voltages are identically applied to the respective SG panels 110 at the same time to generate an identical electric field.

Hereinafter, a driving method of controlling display/non-display of an image according to an age of a user will be described according to an exemplary embodiment of the present invention.

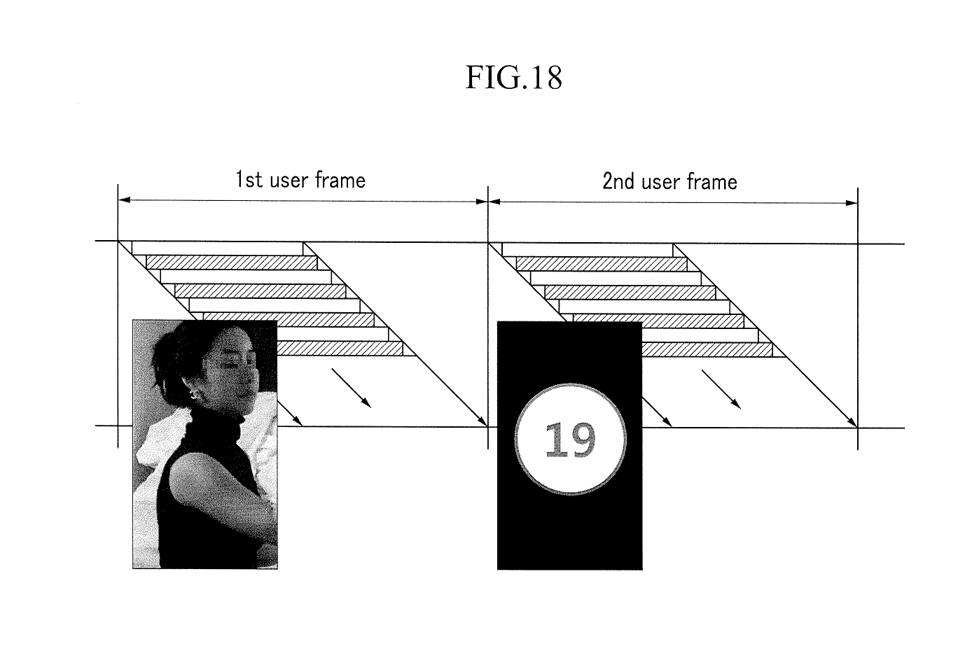

FIG. 18 is a view showing a driving method of the 3D image display device for displaying an image according to an age of a user according to an exemplary embodiment of the present invention.

In the approach illustrated in FIG. 18, the age of the second user is less than 19 (or some other age for which content may be restricted) and the 3D image for the second user is an image that is permitted to be watched by users at 19 years or more, voltage may be applied to the SG panel 110 of the 3D glasses 100 of the second user even in the frame for the second user to apply the electric field thereto. As a result, the second user continuously recognizes only the black.

of the approach illustrated in FIG. 18 may be applied to the cases such as the 3D image for the first user and the 3D image for the second user. For example, the first user at 19 years or more continuously perceives the 3D image, but the second user under 19 years recognizes only the black.

Further, the approach illustrated in FIG. 18 may be applied to only a portion of the entire 3D image. For example, in the case where the user at 19 years or more is permitted to watch a portion of the entire 3D image, the voltage may be applied to the SG panel 110 of the 3D glasses of the user under 19 years only during the corresponding period of time to allow the user to recognize only the black during a predetermined period of time.

Where the voltage is applied to the SG panel 110 of the 3D glasses to generate the electric field, the black frames can be recognized but the 3D image cannot be recognized, but since this is implemented according to setting of directions of the polarization axis and the slow axis of the 3D glasses, the 3D image may be recognized by applying the voltage to the SG panel 110.

While exemplary embodiments of the present invention have been described in connection with the figures, it is to be understood that the invention is not limited to the disclosed embodiments, but is intended to cover various modifications and equivalent arrangements.

What is claimed is:

1. A 3D image display device comprising:
a 3D image display panel;
a patterned retarder formed on an entire surface of the 3D image display panel; and
3D glasses including a lens, the lens comprising an SG panel comprising liquid crystal molecules and a λ/4 plate on an upper surface of the SG panel,
wherein the 3D image display panel and the 3D glasses are synchronized.

2. The 3D image display device of claim 1, wherein:
the patterned retarder comprises a first retarder and a second retarder longitudinally extending in left and right directions and alternately disposed.

3. The 3D image display device of claim 2, wherein:
the first retarder and the second retarder are formed of the λ/4 plate, and
the first retarder and the second retarder are disposed such that slow axes of the λ/4 plates have different directions.

4. The 3D image display device of claim 3, wherein:
the 3D image display panel comprises a first pixel row corresponding to the first retarder, and
a second pixel row corresponding to the second retarder.

5. The 3D image display device of claim 4, wherein:
the first pixel row and the second pixel row are formed of one or more pixel rows.

6. The 3D image display device of claim 3, wherein:
the 3D image display panel comprises:
a liquid crystal panel comprising polarizers attached to a lower portion and an upper portion thereof; and
a backlight.

7. The 3D image display device of claim 1, wherein:
the lens comprises a left lens and a right lens, and
the left lens and the right lens each comprise the SG panel, a lens lower polarizer, a lens upper polarizer, and the λ/4 plate.

8. The 3D image display device of claim 7, wherein:
the SG panel comprises a pair of field generating electrodes and a liquid crystal layer.

9. The 3D image display device of claim 8, wherein:
a difference between polarization directions of two lights transmitted through the SG panel when an electric field is generated and when the electric field is not generated is not generated is 90°.

10. The 3D image display device of claim 7, wherein:
the slow axis of the λ/4 plate of the left lens has the same direction as the slow axis of the λ/4 plate of the right lens.

11. The 3D image display device of claim 10, wherein:
a polarization axis of the lens upper polarizer of the left lens and the polarization axis of the lens upper polarizer of the right lens form a 90° angle with respect to each other.

12. The 3D image display device of claim 11, wherein:
the polarization axis of the lens lower polarizer of the left lens and the polarization axis of the lens lower polarizer of the right lens form a 90° angle with respect to each other.

13. A method for driving a 3D image display device comprising a 3D image display panel comprising a first retarder and a second retarder and 3D glasses comprising a SG panel and a λ/4 plate, the method comprising:
displaying a first-eye image in a first pixel row corresponding to the first retarder;
displaying a second-eye image in a second pixel row corresponding to the second retarder; and
sequentially repeating the displaying of the first-eye image and the second-eye image.

14. The method of claim 13, wherein:
when there are at least two users desiring to watch different 3D images,
the 3D image display device staggers frames for each of at least two users,
only a 3D image for a first user of the at least two users is displayed in the frame for the first user through the repeated displaying of the first-eye image and the second-eye image, and
only the 3D image for a second user of the two or more users is displayed in the frame for the second user through the repeated displaying of the first-eye image and the second-eye image.

15. The method of claim 14, wherein:
the 3D glasses of the second user block light in the frame for the first user, and
the 3D glasses of the first user block light in the frame for the second user.

16. The method of claim 15, wherein:
an electric field is applied to the SG panel to allow the 3D glasses to block light.

17. The method of claim 15, wherein:
when an additional user of the two or more users other than the first user and the second user watches the 3D image for the first user, the 3D glasses of the additional user are identically operated to the 3D glasses of the first user.

18. The method of claim 14, wherein:
the 3D glasses of a given user of the two or more users blocks light corresponding to frames of the 3D image that are designated as not appropriate for viewing by the given user on account of the age of the given user.

19. The method of claim 18, wherein:
the electric field is applied to the SG panel to allow the 3D glasses to block light.

20. 3D glasses for use with a 3D image display device having a pattered retarder formed on an entire surface thereof, the 3D glasses comprising:
a lens;
an SG panel within the lens;
a liquid crystal layer within the SG panel; and
a λ/4 plate on an upper surface of the SG panel,
wherein the 3D glasses are synchronized with the 3D image display device.
